(19) United States
(12) Patent Application Publication
(10) Pub. No.: US 2012/0315879 A1
(43) Pub. Date: Dec. 13, 2012

(54) INTELLIGENT PRESENCE NOTIFICATION SERVICE

(75) Inventors: Mira Vrbaski, Kanata (CA); Sankaranarayanan Sathyanarayan, Stewartsville, NJ (US); Colin L. Kahn, Morris Plains, NJ (US); Mark A. Smith, New Jersey, NJ (US); Edward Grinshpun, New Jersey, NJ (US)

(73) Assignees: ALCATEL-LUCENT USA INC., Murray Hill, NJ (US); ALCATEL-LUCENT CANADA INC., Ottawa (CA)

(21) Appl. No.: 13/156,019

(22) Filed: Jun. 8, 2011

(51) Int. Cl. H04L 12/58

(52) U.S. Cl. 455/412.1

(57) ABSTRACT

Various exemplary embodiments relate to a method performed by a messaging server in a wireless network, the method including: establishing a messaging connection with an intelligent presence server; establishing a messaging connection with a user equipment; receiving a message from the intelligent presence server; and pushing the message to the user equipment.

### TECHNICAL FIELD

Various exemplary embodiments disclosed herein relate generally to using push messaging to provide network alert and other information to user equipment in telecommunications networks.

### BACKGROUND

As the demand increases for varying types of applications within mobile telecommunications networks, service providers must constantly upgrade their systems in order to reliably provide this expanded functionality. This increased functionality along with an increased number of users leads to a need to gather information regarding the status of the network and applications and to provide that information to the user equipment attached to the wireless network.

### SUMMARY

In mobile telecommunication systems various information may be gathered regarding the performance and status of the wireless network and applications. Such information may be very valuable to user equipment (UE) attached to the wireless network. For example, a user equipment may have a limited ability to determine if the base station to which it is connected is congested. The user equipment is able to determine the throughput capability available, but this can vary due to various factors, for example, the distance to the base station or base station antenna gain, which may not be not known to the UE. Accordingly, it would be desirable to provide the user equipment with congestion information to allow the user equipment to switch to another base station or network, or to otherwise alter its behavior.

In light of the present need to provide network information to a UE, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a messaging server in a wireless network, the method including: establishing a messaging connection with an intelligent presence server; establishing a messaging connection with a user equipment; receiving a message from the intelligent presence server; and pushing the message to the user equipment.

A further exemplary embodiment relates to a messaging notification system for a wireless communication system, including: a messaging server configured to receive messages and to push received messages to a user equipment; an intelligent presence server configured to send messages to the user equipment via the messaging server; wherein the intelligent presence server is configured to receive information regarding the status of the wireless network.

A further exemplary embodiment relates to a tangible and non-transitory machine-readable storage medium encoded with instructions for performing by a messaging server in a wireless network comprising: instructions for establishing a messaging connection with an intelligent presence server; instructions for establishing a messaging connection with a user equipment; instructions for receiving a message from the intelligent presence server; and instructions for pushing a message to the user equipment indicating the network alert.

Various embodiments may be further adapted wherein the messaging server uses the Extensible Messaging and Presence Protocol messaging protocol.

Various embodiments may be further adapted wherein the messaging server uses the Session Initiation Protocol messaging protocols.

Various embodiments may be further adapted wherein the message from the intelligent presence server includes information from a network alert message produced by a network monitoring element indicating a status of the wireless network.

Various embodiments may be further adapted wherein the message from the intelligent presence server includes information from application node.

Various embodiments may be further adapted wherein the message from the intelligent presence server includes information related to a change in a subscriber policy.

Various embodiments may be further adapted wherein a messaging ID for a subscriber is the same as the subscriber ID.

Various embodiments may be further adapted wherein the messaging Server hosts the intelligent presence server.

Various embodiments may further include mapping a subscriber ID into a messaging ID for the subscriber associated with the subscriber ID.

### BRIEF DESCRIPTION OF THE DRAWINGS

In order to better understand various exemplary embodiments, reference is made to the accompanying drawings, wherein:

FIG. 1 illustrates an exemplary subscriber network for providing various data services; and

FIG. 2 illustrates an exemplary method for notifying user equipment of network alerts.

FIG. 3 illustrates an exemplary method for notifying user equipment of information from an application node.

### DETAILED DESCRIPTION

Referring now to the drawings, in which like numerals refer to like components or steps, there are disclosed broad aspects of various exemplary embodiments.

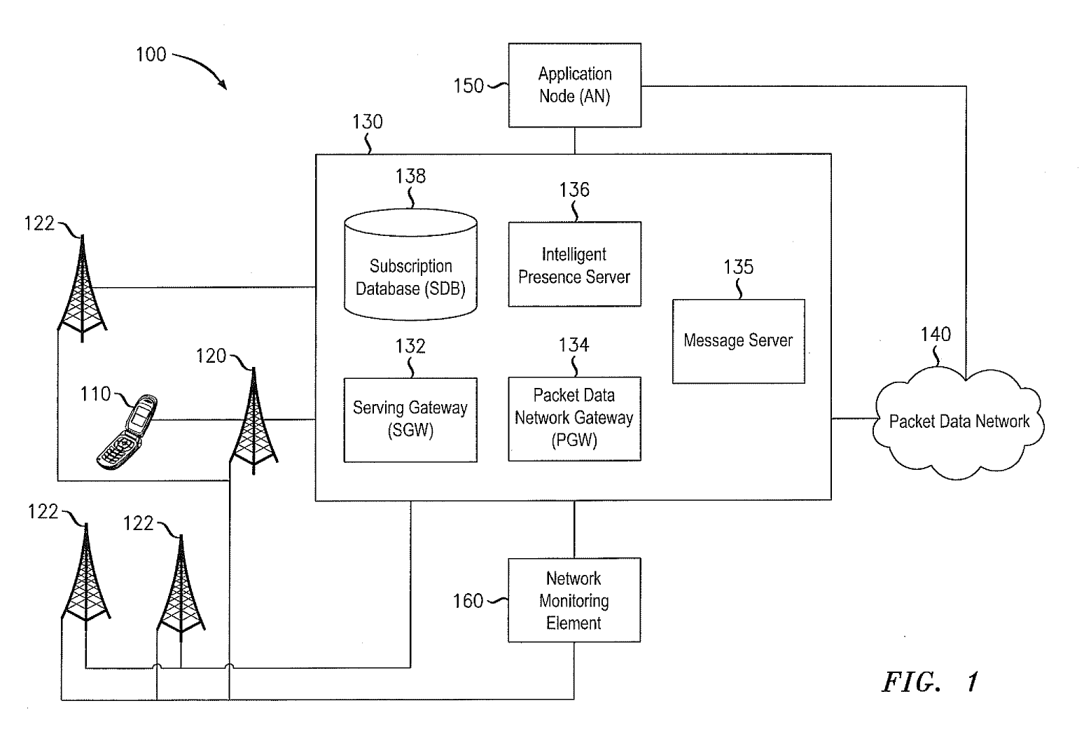

FIG. 1 illustrates an exemplary subscriber network 100 for providing various data services. Exemplary subscriber network 100 may be telecommunications network or other network for providing access to various services. Exemplary subscriber network 100 may include user equipment (UE) 110, base station 120, adjacent base stations 122, packet core network 130, packet data network 140, application node (AN) 150, and network congestion monitoring element 160.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 is a personal, laptop, or tablet computer, wireless email device, cell phone, television set-top box, e-reader, or any other device capable of communicating with other devices via packet core network 130. The user equipment 110 also contains an intelligent presence client in that it receives information from the intelligent presence server 136 indicating the status of the subscriber network 100. Further, the user equipment 110 may include a messaging client for receiving push messages from the messaging server 135. The messaging client may be implemented using the messaging protocol implemented in the messaging server 135. Such push messaging allows the user equipment 110 to receive messages as soon as the messaging server 135 receives messages from the intelligent presence server 136 and to push these messages to the user equipment 110. As a result, the user equipment 110 does not have to periodically poll the intelligent presence server 136 to receive messages.

Base station 120 may be a device that enables communication between user equipment 110 and packet core network 130. For example, base station 120 may be a base transceiver station such as an evolved nodeB (eNodeB) as defined by 3GPP standards. The base station 120 may also be part of a GPRS/EDGE network, a WCDMA network, a 3G1X/EV-DO network, a HSPA/HSPA+ network, or another wireless communication network. Thus, base station 120 may be a device that communicates with user equipment 110 via a first medium, such as radio waves, and communicates with packet core network 130 via a second medium, such as Ethernet cable. Base station 120 may be in direct communication with packet core network 130 or may communicate via a number of intermediate nodes (not shown). In various embodiments, multiple adjacent base stations 122 may also be present to provide mobility to user equipment 110.

Packet core network 130 may be a device or network of devices that provides user equipment 110 with gateway access to packet data network 140. Packet core network 130 may further charge a subscriber for use of provided data services and ensure that particular quality of experience (QoE) standards are met. Thus, packet core network 130 may be implemented, at least in part, according to the 3GPP TS 29.212, 29.213, 29.214, 23.401, and 23.402 standards among others. The packet core network 130 may additionally or alternatively be implemented according to other standards as well. Accordingly, packet core network 130 may include a serving gateway (SGW) 132, a packet data network gateway (PGW) 134, a messaging server 135, intelligent presence server 136, and a subscription database (SDB) 138.

Serving gateway (SGW) 132 may be a device that provides gateway access to the packet core network 130. SGW 132 may be the first device within the packet core network 130 that receives packets sent by user equipment 110. SGW 132 may forward such packets toward PGW 134. SGW 132 may perform a number of functions such as, for example, managing mobility of user equipment 110 between multiple base stations, such as base stations 120, 122, and enforcing particular quality of service (QoS) characteristics for each flow being served. In various exemplary embodiments, packet core network 130 may include multiple SGWs (not shown) and each SGW may communicate with multiple base stations (not shown).

Packet data network gateway (PGW) 134 may be a device that provides gateway access to packet data network 140. PGW 134 may be the final device within the packet core network 130 that receives packets sent by user equipment 110 toward packet data network 140 via SGW 132. PGW 134 may include a number of additional features such as, for example, packet filtering, deep packet inspection, and subscriber charging support. PGW 134 may also be responsible for requesting resource allocation for unknown application services.

The messaging server 135 may be a device that provides a push messaging service. The messaging service may receive messages from various sources. The messaging server may then push messages to desired messaging clients. Specifically, the messaging server 135 may receive network alert information from the network monitoring element 160 via the intelligent presence server 136 that includes a messaging client. Further, the messaging server 135 may push messages including, for example, network alert information to user equipment 110 that also includes a messaging client. The messaging server may use various protocols, for example, Extensible Messaging and Presence Protocol (XMPP), Session Initiation Protocol (SIP), Short Message Service (SMS), Multimedia Messaging Service (MMS), Wireless Application Protocol (WAP), Google Cloud to Device Messaging (C2DM), Apple Notification Service, etc.

The intelligent presence server 136 may be a device that receives network alert information from the network monitoring element 160. Such network alert information may be determined to apply to certain UE's 110 in the wireless network. Further, information related to a certain user equipment 110 may be communicated to the user equipment 110 via the messaging server 135 using a messaging client present on the intelligent presence server 136. The intelligent presence server 136 may also be a device that receives requests for application services, generates rules and policies regarding the operation of the packet core network 130 that may lead to messages being pushed to the user equipment 110. The intelligent presence server 136 may also be in communication with SGW 132 and PGW 134. The intelligent presence server 136 may be or include a policy and charging rules node (PCRN). The intelligent presence server 136 also may include a messaging client, in order to communicate with the messaging server. This messaging client allows the intelligent presence server 136 to push messages to the messaging server 135 that will then push the message to the user equipment 110.

The messaging server 135 and the intelligent presence server 136 may be functions hosted in the same device, server, or network node. Further, the messaging server 135 and the intelligent presence server 136 may be included in a PCRN.

Subscription database (SDB) 138 may be a device that stores information related to subscribers to the subscriber network 100. Thus, SDB 138 may include a machine-readable storage medium such as read-only memory (ROM), random-access memory (RAM), magnetic disk storage media, optical storage media, flash-memory devices, and/or similar storage media. SDB 138 may be a component of intelligent presence server 136 or may constitute an independent node within packet core network 130. Data stored by SDB 138 may include an identifier of each subscriber, an ID for an associated base station, and indications of subscription information for each subscriber such as bandwidth limits, charging parameters, and subscriber priority.

Packet data network 140 may be any network for providing data communications between user equipment 110 and other devices connected to packet data network 140, such as AN 150. Packet data network 140 may further provide, for example, phone and/or Internet service to various user devices in communication with packet data network 140.

Application node (AN) 150 may be a device that provides a known application service to user equipment 110. Thus, AN 150 may be a server or other device that provides, for example, a video streaming or voice communication service to user equipment 110. When AN 150 is to begin providing known application service to user equipment 110, AN 150 may generate an application request message to notify the packet core network 130 that resources should be allocated for the application service. This application request message may include information such as an identification of the subscriber using the application service and an identification of the particular service data flows that must be established in order to provide the requested service.

The network monitoring element 160 may analyze the network activity and capacity. The network monitoring element 160 may identify network behavior that may be characterized as threats or as exceeding certain thresholds. In these cases, the network monitoring element 160 may provide a network alert message to the network platform 136. The network monitoring element 160 may be implemented as software on a server or other processor, as a router, as a gateway, or as any other hardware or software capable of providing this functionality.

Having described the components of subscriber network 100, a brief summary of the operation of subscriber network 100 will be provided. It should be apparent that the following description is intended to provide an overview of the operation of subscriber network 100 and is therefore a simplification in some respects.

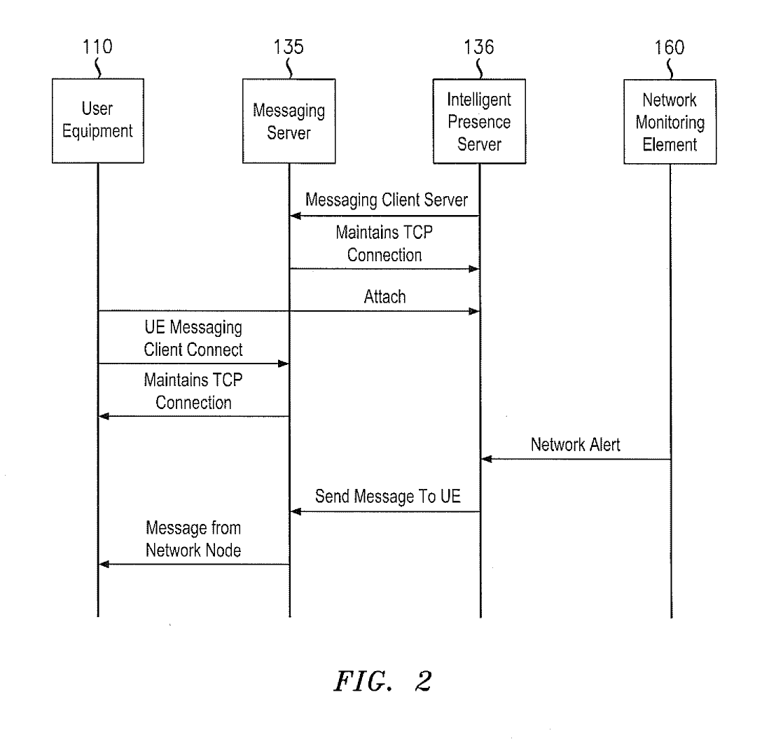

FIG. 2 illustrates the operation of the messaging server 135 with a network monitor 160. The messaging client in the intelligent presence server 136 initiates a connection with the messaging server 135. The messaging server 135 may then establish and maintain a constant communication connection, for example a TCP connection, with the messaging client in the intelligent presence server 136. This connection will allow messages to be pushed between the intelligent presence server 136 and the messaging server 135.

Next the user equipment 110 will attach to the intelligent presence server 136 by sending identification information relating to the user equipment and the subscriber. This information may be used to obtain various subscription information relating to the subscriber from the subscription database 138.

Once the user equipment 110 has attached to the intelligent presence server 136, the user equipment 110 requests a messaging connection with the messaging server 135. The messaging server 135 may then establish and maintain a constant communication connection, for example a TCP connection, with the messaging client in the user equipment 110. In establishing this messaging connection, the user equipment may have a messaging ID that is the same as its subscriber ID. In this case it is easy for the intelligent presence server to send messages to the user equipment 110 using the subscriber ID. If the messaging ID and the subscriber ID are different for a user equipment 110, then a mapping between the two ID's needs to be established. This can be done with a look up table in either the intelligent presence server 136 or the messaging server 135. This allows messages destined for a specific user equipment 110 with a subscriber ID to be sent to the user equipment 110 via the messaging server 135 using the messaging ID for the user equipment 110. Further, multiple subscriber IDs may be associated with a specific user equipment 110, where some of the subscriber IDs may be unique to a specific application.

Once the connections between the user equipment 110, messaging server 135, and intelligent presence server 136 have been established, messages may now be pushed to the user equipment 110. For example, the network monitoring element 160 may detect some network behavior of interest. As a result the network monitoring element 160 may send a message to the intelligent presence server 136 indicating a network alert. The network alert may indicate network congestion, network failures, malicious network attacks, etc. The intelligent presence server 136 may receive the message and may determine if the network alert is applicable to any subscribers. If the network alert is applicable to specific subscribers, then the intelligent presence server 136 may send messages to those subscribers using the messaging server 135. The messaging server 135 may receive a message from the intelligent presence server 136 and then may forward that message to the user equipment 110 associated with the subscriber.

As pointed out before, if the messaging ID for a subscriber is not the same as the subscriber ID for that subscriber, then the subscriber ID may need to be mapped into the proper messaging ID associated with the subscriber. This mapping may be done in either the messaging server 135 or the intelligent presence server 136.

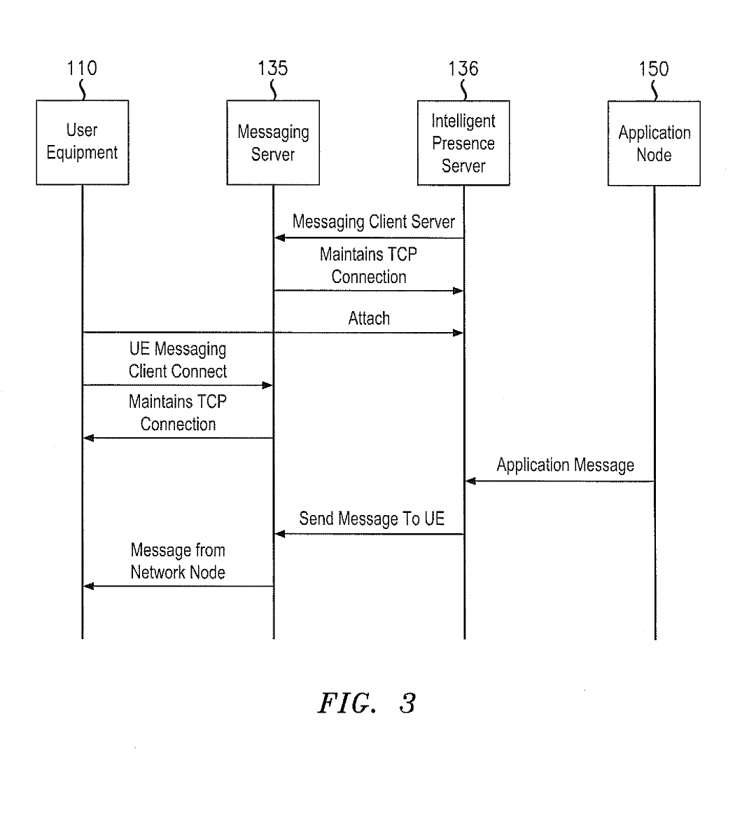

FIG. 3 illustrates the operation of the messaging server 135 with an application node 150. In this embodiment, the connections between the user equipment 110, the messaging server 135, and the intelligent presence server 136 may be established as described above with respect to FIG. 2. In this embodiment, an application node 150 may need to push a message to the user equipment 110. For example, the application node may be a movie server for providing movie content to the user equipment 110. The application node 150 may indicate to the user equipment 110 that the connection to the application node 150 may be terminated because of inactivity. Other notifications are possible as well. The application node 150 may send a message to the intelligent presence server 136 indicating a for example a service request. The intelligent presence server 136 may receive the service request and may determine the subscriber associated with the service request. The intelligent presence server 136 then may send a message to the indentified subscriber using the messaging server 135. The messaging server 135 may receive a message from the intelligent presence server 136 and then may forward that message to the user equipment 110 associated with the subscriber. Again, as described above a mapping of a subscriber ID into a messaging ID may be required.

Further, the messaging server 135 may be used to push other messages to the user equipment 110 as well. For example, if a user is roaming, the intelligent presence server may send a message to the user equipment indicating the cost of roaming. Further, various policies may be installed for a user equipment 110. Often these policies have expiry times, so the intelligent presence server 136 may send a message to the user equipment regarding the expiration, upon which the user equipment 110 may request a new policy. Also, service provider may have special promotions to present to the user, so the messaging service may facilitate pushing information regarding the special promotion to the user equipment. Finally, messaging may be used to instruct the user equipment to install a policy related to some application provided by the application node 150.

It should be apparent from the foregoing description that various exemplary embodiments of the invention may be implemented in hardware and/or firmware. Furthermore, various exemplary embodiments may be implemented as instructions stored on a tangible and non-transitory machine-readable storage medium, which may be read and executed by at least one processor to perform the operations described in detail herein. A tangible and non-transitory machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a messaging server in a wireless network, the method comprising:
establishing a messaging connection with an intelligent presence server;
establishing a messaging connection with a user equipment;
receiving a message from the intelligent presence server; and
pushing the message to the user equipment.

2. The method of claim 1, wherein the messaging server uses the Extensible Messaging and Presence Protocol messaging protocol.

3. The method of claim 1, wherein the messaging server uses one of the following messaging protocols: Session Initiation Protocol, Short Message Service, Multimedia Messaging Service, Wireless Application Protocol, Google Cloud to Device Messaging, and Apple Notification Service.

4. The method of claim 1, wherein the message from the intelligent presence server includes information from a network alert message produced by a network monitoring element indicating a status of the wireless network.

5. The method of claim 1, wherein the message from the intelligent presence server includes information from application node.

6. The method of claim 1, wherein the message from the intelligent presence server includes information related to a change in a subscriber policy.

7. The method of claim 1, further comprising mapping a subscriber ID into a messaging ID for the subscriber associated with the subscriber ID.

8. The method of claim 1, wherein a messaging ID for a subscriber is the same as the subscriber ID.

9. The method of claim 1, wherein the messaging server hosts the intelligent presence server.

10. A messaging notification system for a wireless communication system, comprising:
a messaging server configured to receive messages and to push received messages to a user equipment;
an intelligent presence server configured to send messages to the user equipment via the messaging server;
wherein the intelligent presence server is configured to receive information regarding the status of the wireless network.

11. The system of claim 10, further comprising a network monitoring element configured to monitor the wireless network and to send network alert messages to the intelligent presence server.

12. The system of claim 10, further comprising an application node configured to send an application message to the intelligent presence server.

13. The system of claim 10, further comprising a database that maps a subscriber ID into a messaging ID for the subscriber associated with the subscriber ID.

14. The system of claim 13, further comprising a network node that includes both the messaging server and the intelligent presence server.

15. The system of claim 13, wherein the messaging server uses the Extensible Messaging and Presence Protocol messaging protocol.

16. The system of claim 13, wherein the messaging server uses one of the following messaging protocols: Session Initiation Protocol, Short Message Service, Multimedia Messaging Service, Wireless Application Protocol, Google Cloud to Device Messaging, and Apple Notification Service.

17. A tangible and non-transitory machine-readable storage medium encoded with instructions for performing by a messaging server in a wireless network comprising:
instructions for establishing a messaging connection with an intelligent presence server;
instructions for establishing a messaging connection with a user equipment;
instructions for receiving a message from the intelligent presence server; and
instructions for pushing a message to the user equipment indicating the network alert.

18. The tangible and non-transitory machine-readable storage medium of claim 17, wherein the message from the intelligent presence server includes information from a network alert message produced by a network monitoring element indicating a status of the wireless network.

19. The tangible and non-transitory machine-readable storage medium of claim 17, wherein the message from the intelligent presence server includes information from application node.

20. The tangible and non-transitory machine-readable storage medium of claim 17, wherein the message from the intelligent presence server includes information related to a change in a subscriber policy.
